(19) United States
(12) Patent Application Publication
(10) Pub. No.: US 2016/0251905 A1
(43) Pub. Date: Sep. 1, 2016

(54) SEAL ASSEMBLY FOR WELLBORE TOOL

(71) Applicant: HALLIBURTON ENERGY SERVICES, INC., Houston, TX (US)

(72) Inventors: Luk Servaes, Youngsville, LA (US); Olivier Mageren, Jette (BE); John Gerard Evans, The Woodlands, TX (US); David Wayne Cawthon, Tomball, TX (US)

(21) Appl. No.: 15/029,090

(22) PCT Filed: Nov. 24, 2014
(86) PCT No.: PCT/US2014/067079

§ 371 Date: Apr. 13, 2016

(51) Int. Cl. E21B 10/32; F16J 15/16

(52) U.S. Cl. CPC E21B 10/322; F16J 15/16

(57) ABSTRACT

A seal assembly for a reamer tool positionable in a wellbore includes an annular seal disposed in a longitudinal bore of a tool housing of the reamer tool; an annular wiper disposed upstream of the annular seal in the longitudinal bore; and a tubular sleeve coupled to and movable with a drive mechanism disposed in the longitudinal bore of the tool housing. The tubular sleeve is disposed in a radial gap between the drive mechanism and a surface of the longitudinal bore of the tool housing. The sleeve includes a radial opening through a sidewall of the sleeve, and the tubular sleeve is slidably engageable with the annular seal and with the annular wiper as the drive mechanism is moved through the longitudinal bore of the tool housing.

### TECHNICAL FIELD

This specification generally relates to an assembly and method for sealing a wellbore tool.

### BACKGROUND

During well drilling operations, a drill string is lowered into a wellbore. In some drilling operations the drill string is rotated. Rotation of the drill string provides rotation to a drill bit affixed to the distal end of the drill string. In other drilling operations, a downhole mud motor, rotary steerable system, or a combination thereof disposed in the drill string may be used to operate the drill bit.

In order to pass through the inside diameter of upper strings of casing already in place in the wellbore, or other forms of restriction, often times the drill bit will be of such a size as to drill a smaller gage hole than may be desired for later operations in the wellbore. It may be desirable to have a larger diameter wellbore to enable running further strings of casing and allowing adequate annulus space between the outside diameter of such subsequent casing strings and the borehole wall for a good cement sheath or simply to allow the passage of tubulars through tortuous or highly deviated well paths. It may also be advantageous to adopt such methodology to improve the operating environment through improved well bore cleaning and fluid hydraulic regimes. A borehole opener (reamer) may be included in the drill string above MWD/LWD tools and/or rotary steerable tools. Note as used herein the terms “wellbore reamer,” “borehole opener,” and “under reamer” are interchangeable. Some wellbore reamers are activated by an internal piston system including a drive rod that moves longitudinally inside the body of the wellbore reamer tool to open a plurality of external cutters. Such prior art wellbore reamers may have seal systems that allow debris from the wellbore annulus and carried by drilling fluid to become trapped in annular spaces in the flow path of the fluid through the wellbore reamer tool when the piston system is moved longitudinally. The trapped wellbore debris and particulate matter in the drilling fluid may damage surfaces in the wellbore reamer tool and may wedge in annular spaces causing increasing friction between parts within the tool damaging the tool and/or causes the tool to seize up and fail.

### DESCRIPTION OF DRAWINGS

FIG. 1 is a diagram of an example drilling system including a drilling rig for drilling a wellbore.

FIG. 2A is a side cross-sectional view of a portion of a bottomhole assembly used in the drilling system of FIG. 1 where the bottomhole assembly includes a wellbore reamer tool with the cutters in a closed position.

FIG. 2B is an enlarged portion of FIG. 2A depicting a portion of the wellbore reamer tool.

FIG. 2C is an enlarged portion of FIG. 2B depicting a seal assembly of the wellbore reamer tool.

FIG. 3A is a side cross-sectional view of a portion of a bottomhole assembly including the wellbore reamer tool with the cutters in an open position.

FIG. 3B is an enlarged portion of FIG. 3A depicting a seal assembly of the wellbore reamer tool.

FIGS. 4A-C are progressive side-cross sectional views illustrating the operation of a seal assembly for the wellbore reamer tool.

### DETAILED DESCRIPTION

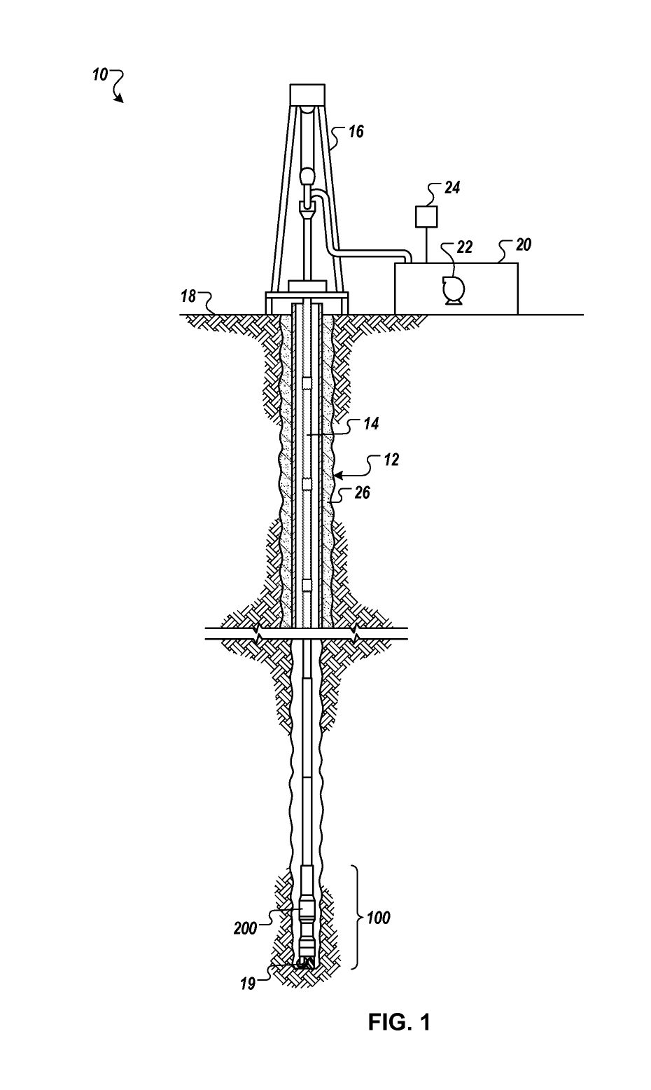

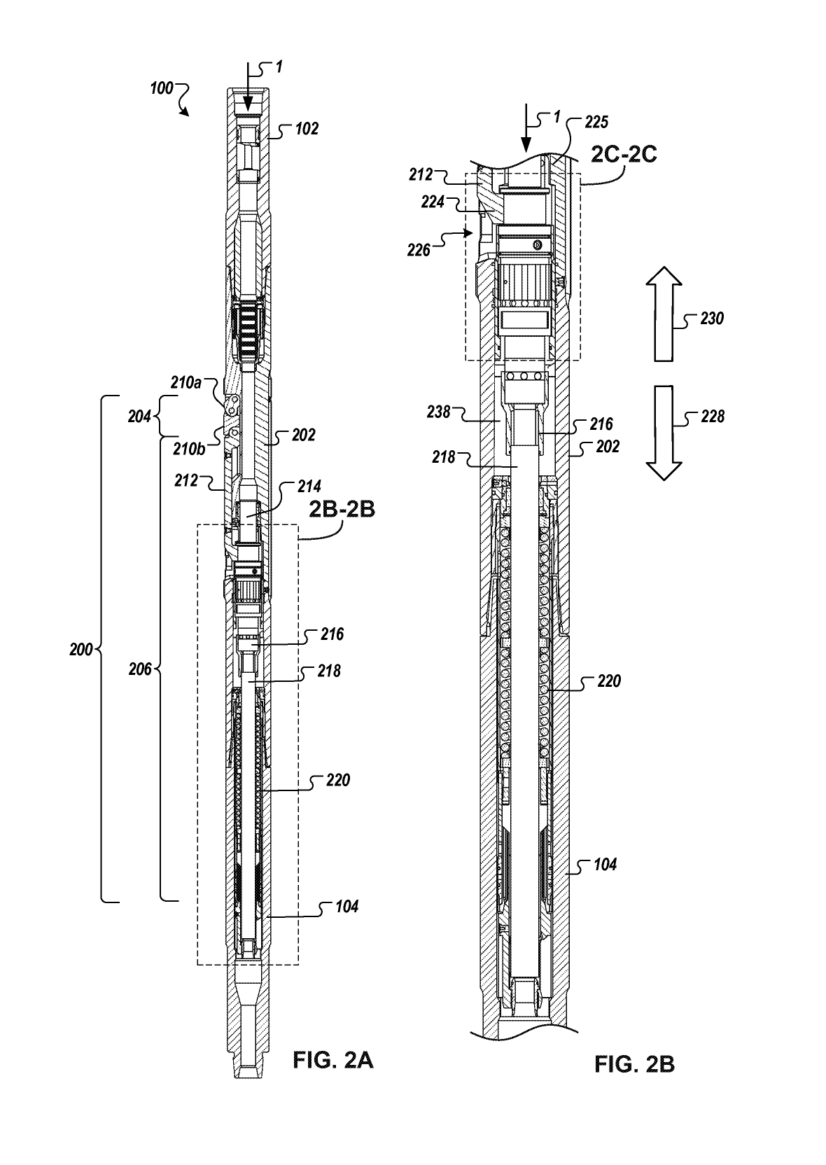

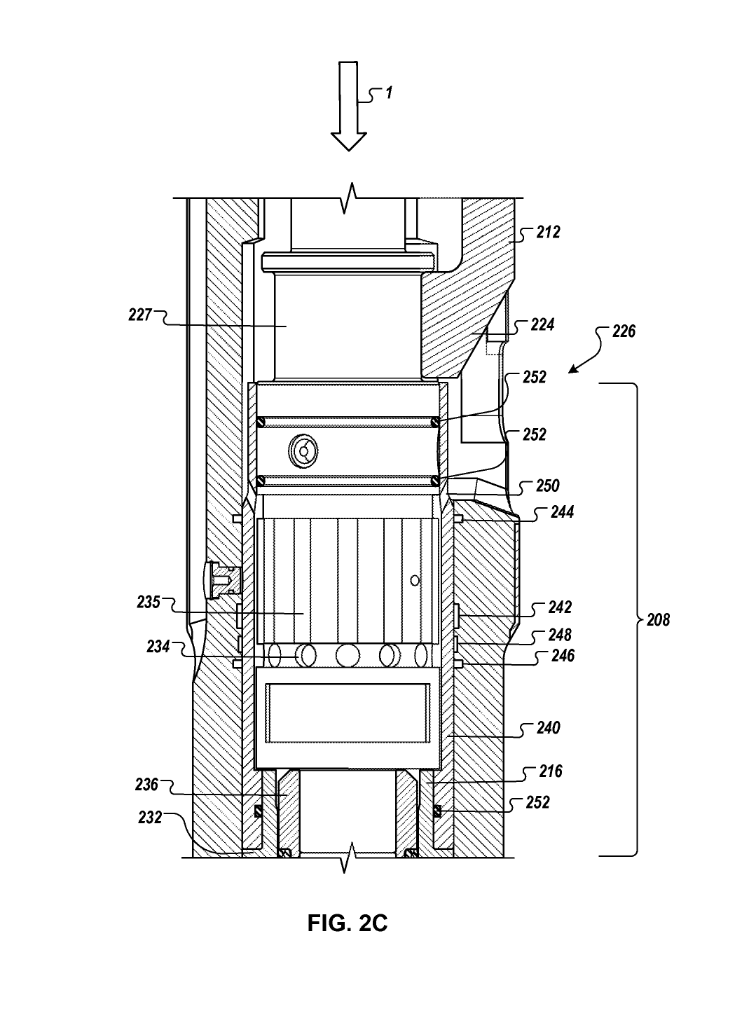

FIG. 1 is a diagram of an example drilling system including a drilling rig 10 for drilling a wellbore 12. The drilling rig 10 includes a drill string 14 supported by a derrick 16 positioned generally on an earth surface 18. The drill string 14 extends from the derrick 16 into the wellbore 12. A bottomhole assembly 100 at the lower end portion of the drill string 14 includes a wellbore tool 200 (e.g., a reamer tool) and a drill bit 19. Various other wellbore tools to facilitate drilling operations may also be included but are known shown. As discussed below with reference to FIG. 2, the wellbore tool 200 is a reamer tool in this example. The drill bit 19 can be a fixed cutter bit, a roller cone bit, or any other type of bit suitable for drilling a wellbore. The drill bit 19 can be rotated by surface equipment that rotates the entire drill string 14 and/or by a subsurface motor (often called a “mud motor”) supported in the drill string.

A drilling fluid supply system 20 includes one or more mud pumps 22 (e.g., duplex, triplex, or hex pumps) to forcibly flow drilling fluid (often called “drilling mud”) down through an internal flow passage of the drill string 14 (e.g., a central bore of the drill string). The drilling fluid supply system 20 may also include various other components for monitoring, conditioning, and storing drilling fluid. A controller 24 operates the fluid supply system 20 by issuing operational control signals to various components of the system. For example, the controller 24 may dictate operation of the mud pumps 22 by issuing operational control signals that establish the speed, flow rate, and/or pressure of the mud pumps 22.

In some implementations, the controller 24 is a computer system including a memory unit that holds data and instructions for processing by a processor. The processor receives program instructions and sensory feedback data from memory unit, executes logical operations called for by the program instructions, and generates command signals for operating the fluid supply system 20. An input/output unit transmits the command signals to the components of the fluid supply system and receives sensory feedback from various sensors distributed throughout the drilling rig 10. Data corresponding to the sensory feedback is stored in the memory unit for retrieval by the processor. In some examples, the controller 24 operates the fluid supply system 20 automatically (or semi-automatically) based on programmed control routines applied to feedback data from the sensors throughout the drilling rig. In some examples, the controller operates the fluid supply system 20 based on commands issued manually by a user.

The drilling fluid is discharged from the drill string 14 through or near the drill bit 19 to assist in the drilling operations (e.g., by lubricating and/or cooling the drill bit), and subsequently routed back toward the surface 18 through an annulus 26 formed between the wellbore 12 and the drill string 14. The re-routed drilling fluid flowing through the annulus 26 carries cuttings from the bottom of the wellbore 12 toward the surface 18. At the surface, the cuttings can be removed from the drilling fluid and the drilling fluid can be returned to the fluid supply system 20 for further use.

In the foregoing description of the drilling rig 10, various items of equipment, such as pipes, valves, fasteners, fittings, etc., may have been omitted to simplify the description. However, those skilled in the art will realize that such conventional equipment can be employed as desired. Those skilled in the art will further appreciate that various components described are recited as illustrative for contextual purposes and do not limit the scope of this disclosure. Further, while the drilling rig 10 is shown in an arrangement that facilitates straight downhole drilling, it will be appreciated that directional drilling arrangements are also contemplated and therefore are within the scope of the present disclosure. Further still, while the drilling rig 10 is depicted as a land based drilling rig, various other types of drilling rigs are contemplated within the scope of the present disclosure (e.g., drilling rigs designed for operation offshore and amidst inland waters).

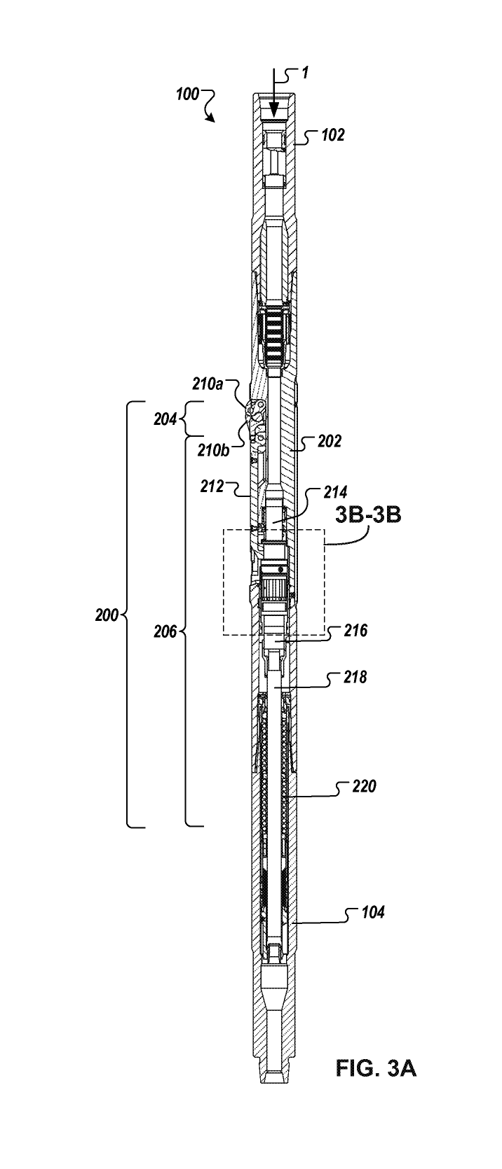

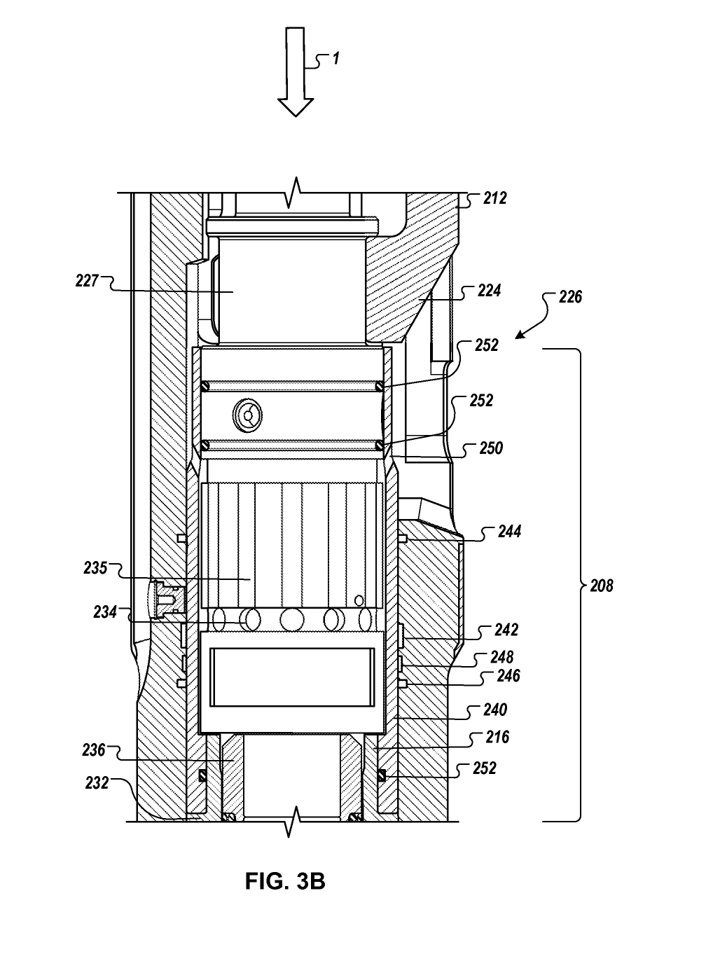

FIGS. 2A-3B are side cross-sectional views of a portion of a bottomhole assembly 100 that can, for example, be incorporated in the drilling rig 10 depicted in FIG. 1. As noted above, in this implementation, the bottomhole assembly 100 is equipped with a wellbore reamer tool 200. The reamer tool 200 includes a tool housing 202 mounted between an upper housing 102 and a lower housing 104 of the bottomhole assembly 100. The upper housing 102 and the lower housing 104 can be coupled to other components of the bottomhole assembly 100 located above and below the reamer tool 200 (e.g., one or more drill collars, stabilizers, shocks, measurement-while-drilling subassemblies, and/or a drill-bit subassembly). Each of the upper housing 102, lower housing 104, and tool housing 202 are elongated tubular members providing a continuous central cavity (e.g., a central bore) for circulating drilling fluid 1. For example, drilling fluid 1 may flow through the bore of the bottomhole assembly, out the drill bit, and up through the wellbore annulus 26 toward the drilling fluid supply system 20 at the surface 18.

The wellbore reamer tool 200 includes the tool housing 202, an arrangement of cutters 204, a drive mechanism 206, and a seal assembly 208. The cutters 204 are distributed circumferentially about the tool housing 202. In some examples, the reamer tool 200 includes three cutters 204 located at circumferential intervals of 120° about a central axis of the tool housing 202. Of course, any suitable arrangement of cutters may be used in various other embodiments and implementations without departing from the scope of the present disclosure. In this example, each of the cutters 204 includes a pair of cutting arms 210a and 210b that form an angular articulation movable between a retracted position (see FIG. 2A) and a deployed position (see FIG. 3A). In the retracted position, the cutting arms 210a and 210b are held against the tool housing 202. In the deployed position, the cutting arms 210a and 210b extend radially outward from the tool housing 202 to engage the wall of the wellbore 12. The cutting arms 210a and 210b can include cutting tips (e.g., PDC cutter inserts, diamond insert cutters, hard-faced metal inserts) that abrade and cut away the formation along the wall of the wellbore 12 as the reamer tool 200 is rotated with the bottomhole assembly 100, thereby expanding the diameter of the wellbore 12. Other suitable configurations for the cutter arms may also be used (e.g., single block and/or piston configurations) without departing from the scope of the present disclosure.

The drive mechanism 206 includes a plurality of transmission arms 212, an upper drive rod 214, a lower drive rod 216, an extension rod 218, and a biasing member 220. Each of the transmission arms 212 is coupled between a respective cutting arm 210b and the upper drive rod 214. In this example, the transmission arms 212 are mounted to slide longitudinally along an outer surface of the tool housing 202. Further, each of the transmission arms includes a prong member 224 that projects into the bore 225 of the tool housing 202 through an elongated radial slot 226 to engage an annular groove 227 of the upper drive rod 214 (see FIGS. 2C and 3B). Thus, longitudinal movement of the upper drive rod 214 in an upward (e.g. ‘uphole”) direction causes mimicking longitudinal movement of the transmission arms 212 in an upward direction to effect deployment or retraction of the respective cutting arms 210a and 210b. In particular, when the upper drive rod 214 is driven upwards (relative to the tool housing 202), the resulting upward translation of the transmission arms 212 causes the articulated cutting arms 210a and 210b to flex outward into the deployed position. And when the upper drive rod 214 is driven downwards (relative to the tool housing 202), the resulting downward translation of the transmission arms 212 causes the articulated cutting arms 210a and 210b to fold inward into a retracted position.

The upper drive rod 214 is coupled to the lower drive rod 216; the lower drive rod 216 is coupled to the extension rod 218; and the biasing member 220 is mounted in the tool housing 202 and the lower housing 104 to exert a ubiquitous downward biasing force 228 on the extension rod 218. The downward biasing force 228 provided by the biasing member 220 may be opposed by an upward net hydraulic pressure force 230. During drilling operations, the upward net hydraulic pressure force 230 may overcome the downward biasing force 228 and cause upward movement of the extension rod 218, the lower drive rod 216 and the upper drive rod 214. As described above, such upward movement of the upper drive rod 214 can cause deployment the cutting arms 210a and 210b via the transmission arms 212. As described below, the net hydraulic pressure force 230 is created by establishing a relatively low pressure fluid chamber and relatively high pressure fluid chamber on either side of a radial flange component 232 of the lower drive rod 216 (see FIGS. 2C and 3B).

Referring to FIGS. 2A, 2B and 3A, the upper drive rod 214 is a tubular member mounted to translate longitudinally through the bore 225 of the tool housing 202. The hollow bore of the upper drive rod 214 is in fluid communication with the bore 225 of the tool housing 202 to receive the circulating flow of drilling fluid 1. As illustrated in the enlarged cross sections 2C and 3B and described below, radial holes 234 traversing the cylindrical side wall of the upper drive rod 214 allow fluid from the wellbore annulus 26 to flow inward into the inner bore of the upper drive rod 214 via the radial slot 226 in the tool housing 202. Longitudinal channels 235 formed in the sidewall of the upper drive rod 214 are aligned with the radial holes 234 to facilitate this inward fluid flow.

A tubular plug member 236 is fixedly mounted within the bore of the upper drive rod 214, such that an upper fluid chamber (not shown) is formed between an outer surface of the plug member 236 and an inner surface of the upper drive rod 214. The upper fluid chamber is located above the radial flange component 232 of the lower drive rod 216. This upper fluid chamber contains the relatively low pressure fluid from the wellbore annulus 26. The upper fluid chamber is sealed from the circulating flow of drilling fluid 1 passing through the inner bore of the plug member 236. Radial holes 239 traversing the cylindrical side wall of the lower drive rod 216 permit drilling fluid 1 circulating through the tool housing 202 to enter a lower fluid chamber 238. The lower fluid chamber 238 is located below the radial flange component 232 of the lower drive rod 216. Thus, the upward net hydraulic pressure force 230 is created when the pressure of the drilling fluid 1 held in the lower fluid chamber 238 is greater than the low pressure fluid held in the upper fluid chamber. The upward net pressure force 230 acts on the radial flange component 232 of the lower drive rod 216 to oppose the downward biasing force 228 on the extension rod 218 exerted by the biasing member 220.

As illustrated in the enlarged cross sections 2C and 3B, the seal assembly 208 includes multiple components that cooperate to effectively seal the upper fluid chamber from the lower fluid chamber 238 across the radial flange component 232 of the lower drive rod 216. In this example, the seal assembly 208 includes a tubular sleeve 240, a sealing element 242, an upper wiper 244, a lower wiper 246, and a load ring 248. As shown, the tubular sleeve 240 is carried by the upper drive rod 214 and the lower drive rod 216, and disposed in a radial gap between the outer surface drive rods and the surface of the longitudinal bore 225 of the tool housing 202. In this example, the tubular sleeve 240 extends along a lower portion of the upper drive rod 214, from just below the annular groove 227, to sit against the radial flange component 232 of the lower drive rod 216. The cylindrical side wall of the tubular sleeve 240 includes a radial opening 250 fluidically coupled to the elongated radial slot 226 of the tool housing 202. During drilling operations, fluid from the wellbore annulus 26 enters the tool housing 202 flowing inward form the annular through the elongated radial slot 226, passing through the radial opening 250 of the tubular sleeve 240, and traversing the longitudinal channels 235 to reach the radial holes 234 of the upper drive rod 214. As noted above, fluid passing through the radial holes 234 enters the upper fluid chamber (not shown). O-ring seals 252 inhibit leakage of the fluid entering the radial opening 250 from the tubular sleeve 240.

The sealing element 242, upper wiper 244, lower wiper 246, and load ring 248 are located in radial seal grooves formed in the bore 225 of the tool housing 202. Thus, these components of the seal assembly 208 remain stationary while the upper drive rod 214 and the lower drive rod 216 move longitudinally through the bore 225 of the tool housing 202. Mounting the sealing element 242 in a stationary position maintains the volume of the upper fluid chamber (not shown) and the lower fluid chamber 238 during drilling operations. Maintaining a constant volume of the fluid chambers may reduce the risk of fluid leakage and/or ingress of contaminants. Further, placement of these components within seal grooves of the tool housing 202 may allow for installation of the seal assembly 208 prior to insertion of the drive mechanism 206, which avoids a multi-step complex seal assembly process (e.g., a V-pack or chevron type seal) that would use a conventional seal box.

In this example, the sealing element 242 is provided in the form of a rod seal having a sealing lip engaging the outer surface of the tubular sleeve 240 to at least inhibit (if not prevent) fluid leakage between the upper fluid chamber (not shown) and the lower fluid chamber 238. The upper and lower wipers 244 and 246 are disposed on either side of the sealing element 242. The wipers 244 and 246 cooperate with the outer surface of the tubular sleeve 240 to inhibit (if not prevent) contaminants (e.g., dirt and debris) from encountering the sealing element 242. In this example, the upper wiper 244 is located near the edge of the tool housing's elongated radial slot 226 to reduce any risk of dirt and debris being trapped between the tubular sleeve 240 and the tool housing 202, which may cause jamming of the reamer tool 200. In some implementations, at least the upper wiper 244, which is exposed to fluid from the wellbore annulus 26, may be particularly designed for operation in an environment teeming with wellbore debris and particulate matter. As one example, the upper wiper 244 may be formed from a high strength and abrasion resistant material.

The load ring 248 is proximal to the sealing element 242 within the bore 225 of the tool housing 202. The load ring 248 is a load bearing member that provides stiffness to the bottomhole assembly 100 in the area of the seal assembly 208. In some examples, the load ring 248 protects the sealing element 242 from damage when the bottomhole assembly 100 is subjected to substantial bending moments during drilling operations. For instance, the load ring 248 may ensure the centralization of the upper drive rod 214 relative to the sealing element 242 mounted in the bore 255 of the tool housing 202. Supporting the upper drive rod 214 in a substantially fixed radial position relative to the sealing element 242 may inhibit dynamic eccentricity which could result in fluid leakage and/or ingress of debris. Thus, the load ring 122 may increase the drilling conditions under which the reamer tool 200 can effectively operate.

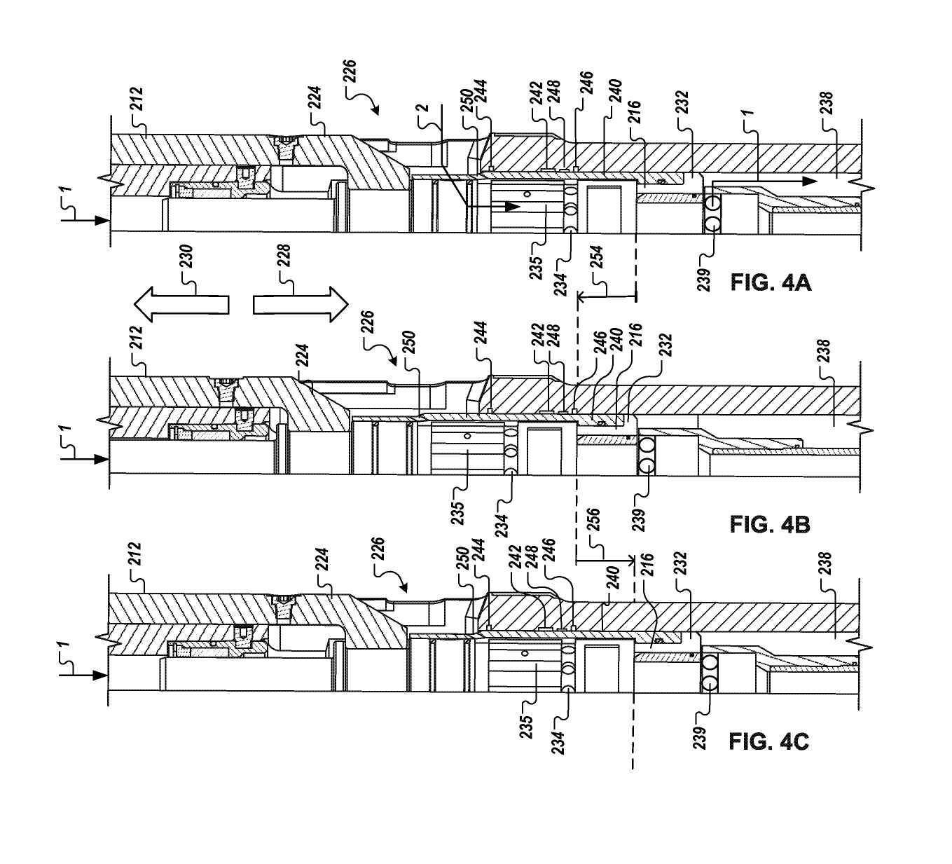

FIGS. 4A-4C are progressive side-cross sectional views illustrating the operation of the drive mechanism 206 and the seal assembly 208 of the reamer tool 200. As noted above, the drive mechanism 206 causes deployment and retraction of the articulating cutting arms 210a and 210b. In particular, movement of the upper drive rod 214 in an upward longitudinal direction causes deployment of the cutting arms 210a and 210b via the transmission arm 212. Movement of the upper drive rod 214 is achieved when the pressure difference between the upper fluid chamber (not shown) and the lower fluid chamber 238 creates an upward net hydraulic pressure force 230 greater than the downward biasing force 228 exerting by the biasing member 220. The upper fluid chamber contains fluid 2 from the wellbore annulus 26; and lower fluid chamber 238 contains circulating drilling fluid 1.

In some examples, pressure variations in the lower fluid chamber 238 may be created by changes in the flow rate of the drilling fluid 1, which can be produced by operation of the mud pumps 22 via the controller 24. However, the present disclosure is not so limited. Any suitable method of increasing or decreasing the hydraulic pressure in the lower fluid chamber 238 can be employed without departing from the scope of the present disclosure. For example, a drop-ball method could be used to control the lower fluid chamber pressure.

An increase in the hydraulic pressure of the lower fluid chamber 238 (e.g., when the mud pumps 22 are activated or operated at a high drilling fluid flow rate) builds the upward net hydraulic pressure force 230 that acts on the radial flange component 232 of the lower drive rod 216. When the net hydraulic pressure force 230 overcomes the downward biasing force 228, the upper drive rod 214 executes an upstroke 254 to deploy the cutting arms 210a and 210b (see transition from FIG. 4A to FIG. 4B). Conversely, a decrease in the hydraulic pressure of the lower fluid chamber 238 (e.g., when the mud pumps 22 are deactivated or operated at a low flow setting) weakens the net hydraulic pressure force 230, which allows the downward biasing force 228 to cause the upper drive rod 214 to execute a downstroke 256 that retracts the cutting arms 210 and 210b (see transition from FIG. 4B to FIG. 4C). The seal assembly 208 operates to maintain the integrity of the upper fluid chamber (not shown) and the lower fluid chamber 238 as the upper drive rod 214 and the lower drive rod 216 move longitudinally through the bore 225 of the tool housing 202 during the upstroke 254 and the downstroke 256.

A number of embodiments of the invention have been described. Nevertheless, it will be understood that various modifications may be made without departing from the spirit and scope of the following claims. For example, in one or more alternative implementations the tubular sleeve may be formed integrally with the upper drive rod. Further, while the above examples incorporate a conventional linear spring (e.g., a coil spring or a disk spring) for providing downward biasing force, other suitable biasing members can also be used for this purpose (e.g., a gas spring or a magnetic spring).

1. A seal assembly for a reamer tool positionable in a wellbore, said seal assembly comprising:
an annular seal disposed in a sidewall of a longitudinal bore of a tool housing of the reamer tool;
an annular wiper disposed in the sidewall of the longitudinal bore upstream of the annular seal in the longitudinal bore; and
a tubular sleeve coupled to and movable with a drive mechanism disposed in the longitudinal bore of the tool housing, the sleeve disposed in a radial gap between the drive mechanism and a surface of the side wall of the longitudinal bore of the tool housing, the sleeve including a radial opening through a sidewall of the sleeve, and the tubular sleeve being slidably engageable with the annular seal and with the annular wiper as the drive mechanism is moved through the longitudinal bore of the tool housing.

2. The seal assembly of claim 1, wherein the radial opening through the tubular sleeve is adapted to fluidically connect an upper chamber of the drive mechanism to an annulus between a side wall of the wellbore and an outer surface of the tool housing.

3. The seal assembly of claim 1, wherein the annular seal comprises a rod seal mounted in a radial seal groove of the bore of the tool housing.

4. The seal assembly of claim 1, wherein the annular wiper is mounted in a radial seal groove above the annular seal and proximate an edge of an elongated radial slot formed in the side wall of the tool housing.

5. The seal assembly of claim 1, further including a load ring disposed in the bore of the tool housing proximal to the annular seal.

6. The seal assembly of claim 1, further including a second annular wiper disposed downstream of the annular seal in the bore, such that the annular seal is located between the first and second annular wipers.

7. The seal assembly of claim 6, wherein the first annular wiper, disposed upstream of the annular seal in the bore, is formed from a high strength and abrasion resistant material.

8. A downhole wellbore tool, comprising:
a tool housing having an a longitudinal bore;
a drive mechanism including an upper drive rod located within the longitudinal bore of the tool housing; and
a seal assembly
an annular seal disposed in a sidewall of the longitudinal bore of the tool housing;
an annular wiper disposed in a sidewall of the longitudinal bore upstream of the annular seal in the longitudinal bore; and
a tubular sleeve coupled to and movable with the upper drive rod within the bore, the sleeve disposed in a radial gap between the upper drive rod and a surface of the sidewall of the longitudinal bore of the tool housing, the sleeve including a radial opening through a sidewall of the sleeve fluidically connecting an upper fluid chamber of the upper drive rod to an annulus of a wellbore, and the sleeve being slidably engageable with the annular seal and with the annular wiper as the upper drive rod is moved longitudinally through the longitudinal bore.

9. The wellbore tool of claim 8, wherein the annular seal is positioned within the bore to inhibit leakage of fluid from the upper fluid chamber.

10. The wellbore tool of claim 8, further including a lower fluid chamber containing high-pressure drilling fluid to provide an upward net hydraulic pressure force urging the upper drive rod to move longitudinally upward through the bore.

11. The wellbore tool of claim 8, further including a biasing member exerting a downward biasing force urging the upper drive rod to move longitudinally downward through the bore.

12. The wellbore tool of claim 8, further including a cutter coupled to a transmission arm movable with the upper drive rod, the cutter being movable from a retracted position to a deployed position in response to longitudinal movement of the transmission arm with the upper drive rod.

13. The wellbore tool of claim 12, wherein the cutter includes a pair of articulated cutting arms, at least one of the cutting arms including a plurality of cutting tips to abrade and cut away formation along the well of the wellbore.

14. A method of annular sealing a drive mechanism disposed in a tool housing of a wellbore tool, the method comprising:
flowing fluid from a wellbore annulus through a radial opening of a tubular sleeve disposed in a longitudinal bore of the tool housing and carried on an outer surface of an upper drive rod of the drive mechanism;
annular sealing an upper fluid chamber from a lower fluid chamber by engaging an annular seal disposed in the side wall of the longitudinal bore with the tubular sleeve as the upper drive rod moves longitudinally through the bore of the tool housing; and
inhibiting ingress of wellbore debris and particulate matter in the fluid into a radial gap between the upper drive rod and a surface of the bore of the tool housing by engaging an annular wiper disposed in the side wall of the longitudinal bore upstream of the annular seal in the bore with the tubular sleeve.

15. The method of claim 14, wherein the annular seal comprises a rod annular seal mounted in a radial seal groove of the bore of the tool housing.

16. The method of claim 14, wherein the annular wiper is mounted in a radial seal groove above the annular seal and proximate an edge of an elongated radial slot formed in the side wall of the tool housing.

17. The method of claim 14, wherein inhibiting ingress of wellbore debris and particulate matter further includes engaging a second annular wiper disposed downstream of the annular seal in the bore with the tubular sleeve.
